(19) United States
(12) Patent Application Publication
(10) Pub. No.: US 2026/0266338 A1
(43) Pub. Date: Sep. 10, 2026

(54) VARIABLE ANGLE TORQUE TUBE INTERFACE WITH HARD STOP

(71) Applicant: ARRAY TECH, INC., Albuquerque, NM (US)

(72) Inventors: Shuo Chen, Chandler, AZ (US); Thierry Marin-Martinod, Chandler, AZ (US); Nathan Schuknecht, Golden, CO (US); Song Wang, Peoria, AZ (US)

(21) Appl. No.: 19/559,068

(22) Filed: Mar. 6, 2026

Related U.S. Application Data
(60) Provisional application No. 63/767,958, filed on Mar. 6, 2025.

(51) Int. Cl. F16C 35/02; H02S 20/32

(52) U.S. Cl. CPC F16C 35/02; H02S 20/32

(57) ABSTRACT

A variable angle torque tube interface is provided that includes a bearing configured to be coupled to a torque tube. The bearing may have an external surface that includes a rounded portion and a portion that defines a circumferential channel. The variable angle torque tube interface may also include a bearing housing coupled to the bearing that defines an axial channel and has a rounded internal surface portion. The variable angle torque tube interface may also include a pin positioned at least partially within the circumferential channel and at least partially within the axial channel to allow the at least some rotation by the bearing within the bearing housing about a tracking axis, a pitch axis, and a yaw axis and limit an amount rotation by the bearing within the bearing housing about the tracking axis.

### CROSS-REFERENCE TO RELATED APPLICATIONS

This application claims priority under 35 U.S.C. §119 to U.S. Provisional Application No. 63/767,958, filed Mar. 6, 2025, the entire disclosure of which is incorporated herein by reference.

### FIELD

The present disclosure relates to solar energy production and more particularly to a variable angle torque tube interface with a hard stop for securing a torque tube to a support pile in a photovoltaic (PV) system.

### BACKGROUND

PV modules in solar panel systems may be attached to a support structure, or pile. The PV modules may be mounted in rows on solar trackers that direct an orientation of the PV modules such that the angle of the PV modules with respect to the support structure changes throughout the day. Changing the angle of the PV module with respect to the support structure enables the PV module to track the location of the Sun and maximize efficiency. Often, a large number of PV modules are mounted to a single torque tube, which is secured to one or more piles or other support structures, through one or more torque tube interfaces. Torque tube interfaces often include both a bearing and bearing housing. The bearings are often configured to rotate about a tracking axis so that the bearings can rotate with the torque tube within the bearing housing to track the location of the Sun. However, due to terrain inconsistencies and installation imprecision, bearings may also be configured to rotate about a pitch axis and/or a yaw axis within the bearing housing.

While some rotation about the tracking axis by the bearing within the bearing housing is necessary to allow the PV modules to track the location of the Sun in the sky, this rotation creates additional torque and force on components of the tracking system. For example, as a torque tube is rotated about the tracking axis and away from a balanced horizontal position, the amount of rotational force that results from overhanging weight of PV modules increases. The torque generated from this overhanging weight can be substantial and can be significant at the rotational limits of the tracking system. Over time, this torque can cause damage to the motor, gears, and other components of the tracking system. Damage to these components is often expedited by external factors and forces such as wind, snow accumulation on the PV modules, and seismic activities, which can create additional rotational torque on the tracking system.

In order to prevent over-rotation of the torque tube, a torque tube interface may include a stop component that physically prevents a torque tube from rotation beyond a designed amount. For example, the stop may be configured to lock, cease, or limit rotation of the torque tube and PV modules beyond a certain angle. Thus, a stop mechanism may prevent over-rotation or rotation outside of the operational range of the tracking system. However, there is a need for an improved torque tube interface that includes a stop component that prevents over-rotation about the tracking axis but still allows for some rotation about the pitch and/or yaw axis.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

In one embodiment, a variable angle torque tube interface is provided that includes a bearing configured to be coupled to a torque tube. The bearing may have an external surface that includes a rounded portion and a portion that defines a circumferential channel. The variable angle torque tube interface may also include a bearing housing coupled to the bearing that defines an axial channel and has a rounded internal surface portion. The rounded internal surface portion of the bearing housing may interface with the rounded external surface portion of the bearing to allow the bearing at least some rotation within the bearing housing about a tracking axis, a pitch axis, and a yaw axis. The variable angle torque tube interface may also include a pin positioned at least partially within the circumferential channel and at least partially within the axial channel to allow the at least some rotation by the bearing within the bearing housing about the tracking axis, the pitch axis, and the yaw axis and limit an amount rotation by the bearing within the bearing housing about the tracking axis.

In some embodiments, the circumferential channel may be rectangular.

In some embodiments, the circumferential channel on the bearing may extend less than half of an entire circumference of the bearing.

In some embodiments, the axial channel may be rectangular.

In some embodiments, the bearing housing may be bifurcated and include an upper section and a lower section. In these embodiments, the axial channel may be in the upper section of the bifurcated bearing housing and extend through an entire thickness of the bearing housing such that the axial channel forms an aperture in the bearing housing. In these embodiments, the pin may include a head portion, a foot portion, and a central portion. The head portion of the pin may extend through the axial channel aperture and outside the bearing housing and the foot portion may be seated within the circumferential channel. In these embodiments, the central portion may be cylindrical.

Alternatively, in embodiments where the bearing housing is bifurcated and includes an upper section and a lower section, the axial channel may be in the lower section of the bifurcated bearing housing. In these embodiments, the axial channel may not extend through an entire width of the bearing housing such that the pin is enclosed between the bearing housing and the bearing.

In some embodiments, the bearing may be bifurcated and include an outer component and an inner component. In these embodiments, the outer component may be made of a composite material and the inner component may be made of a metal.

In some embodiments, the pin may be bifurcated and include a head portion and a foot portion. In these embodiments, at least one of the head portion and foot portion may define an aperture and at least one of the head portion and foot portion may include a prong that is configured to fit within the defined aperture to allow the head portion and foot portion to rotate relative to each other.

In some embodiments, the pin may also limit an amount of rotation by the bearing within the bearing housing about the pitch axis and/or the yaw axis.

In another embodiment, a variable angle torque tube interface is provided that includes a bearing configured to be attached to a torque tube. The bearing may define a circumferential channel having a rounded external surface portion. The variable angle torque tube interface may also include a bearing housing coupled to the bearing. The bearing housing may define an axial channel and have a rounded internal surface portion. The rounded internal surface portion of the bearing housing may interface with the rounded external surface portion of the bearing to allow the bearing at least some rotation within the bearing housing about a tracking axis, a pitch axis, and a yaw axis. The variable angle torque tube interface may also include a pin positioned at least partially within the circumferential channel and at least partially within the axial channel to allow the at least some rotation by the bearing within the bearing housing about the tracking axis, the pitch axis, and the yaw axis and limit an amount rotation by the bearing within the bearing housing about the tracking axis. The axial channel in the bearing housing may not extend through an entire width of the bearing housing such that the pin is enclosed between the bearing housing and the bearing.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example PV system with a variable angle torque tube interface with hard stop;

FIG. 2 illustrates a perspective view of an example variable angle torque tube interface with hard stop;

FIGS. 3A-3B illustrate various views of a bearing housing that is part of the variable angle torque tube interface with hard stop shown in FIG. 2;

FIGS. 4A-4B illustrate various views of a bearing that is part of the variable angle torque tube interface with hard stop shown in FIG. 2;

FIGS. 5A-5B illustrate various views of a pin that is part of the variable angle torque tube interface with hard stop shown in FIG. 2;

FIG. 6 illustrates an exploded view of the variable angle torque tube interface with hard stop shown in FIG. 2;

FIGS. 7A-7C illustrate rotation about a tracking axis of the variable angle torque tube interface with hard stop shown in FIG. 2;

FIGS. 8A-8B illustrate rotation about a pitch axis of the variable angle torque tube interface with hard stop shown in FIG. 2;

FIGS. 9A-9B illustrate rotation about a yaw axis of the variable angle torque tube interface with hard stop shown in FIG. 2.

FIG. 10 illustrates a perspective view of another example variable angle torque tube interface with hard stop;

FIGS. 11A-11D illustrate various views of a bearing housing that is part of the variable angle torque tube interface with hard stop shown in FIG. 10;

FIGS. 12A-12D illustrate various views of a bearing that is part of the variable angle torque tube interface with hard stop shown in FIG. 10;

FIGS. 13A-13D illustrate various views of a pin that is part of the variable angle torque tube interface with hard stop shown in FIG. 10;

FIG. 14 illustrates an exploded view of the variable angle torque tube interface with hard stop shown in FIG. 10;

FIGS. 15A-15C illustrate rotation about a tracking axis of the variable angle torque tube interface with hard stop shown in FIG. 10;

FIGS. 16A-16D illustrate rotation about a pitch axis of the variable angle torque tube interface with hard stop shown in FIG. 10;

FIGS. 17A-17B illustrate rotation about a yaw axis of the variable angle torque tube interface with hard stop shown in FIG. 10.

### DETAILED DESCRIPTION

Embodiments of the present disclosure are explained with reference to the accompanying Figures. It is to be understood that the figures are diagrammatic and schematic representations of such example embodiments, and are not limiting, nor are they necessarily drawn to scale. In the Figures, features with like numbers indicate like structure and function unless described otherwise.

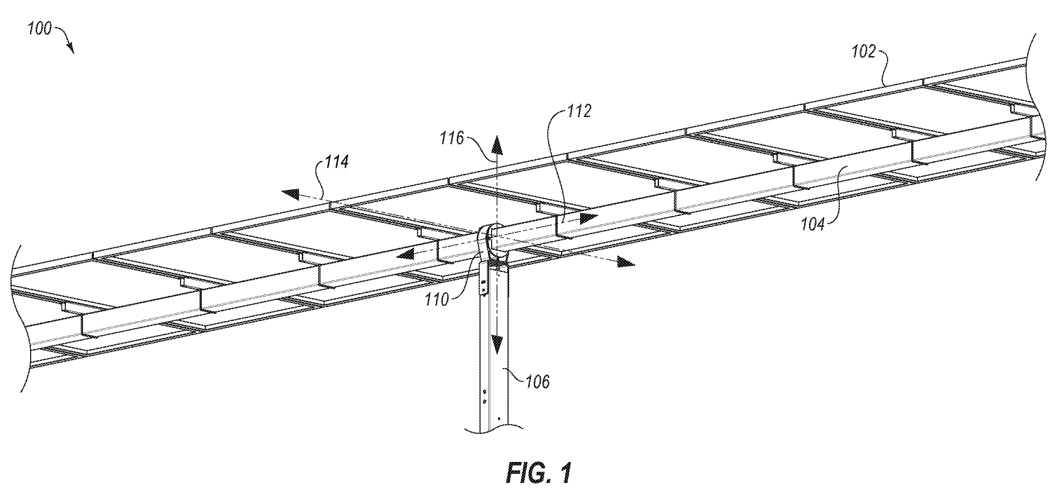

FIG. 1 illustrates an example photovoltaic (PV) system 100. The example PV system 100 includes PV modules 102, a torque tube 104, a support structure or pile 106, and a variable angle torque tube interface 110. As provided in more detail hereafter, the variable angle torque tube interface 110 may include a bearing housing (not shown), a bearing (not shown), and a hard stop mechanism (not shown). The bearing housing may be attached to the pile 106 either directly or indirectly through one or more brackets. The bearing may be attached to the torque tube 104 such that the bearing is not able to slide along the torque tube but is secured to a fixed location on the torque tube. The bearing housing may define an aperture, which the bearing may be positioned substantially within such that the bearing is permitted at least some rotation about a tracking axis 112, a pitch axis 114, and a yaw axis 116. The bearing, however, is prevented from lateral movement relative to the bearing housing 108 along any of the tracking axis 112, the pitch axis 114, or the yaw axis 116.

Allowing the bearing to rotate about the pitch axis 114 and the yaw axis 116 allows for some variation in terrain as well as some imprecision in the system installation by allowing some up and down and side to side tilt relative to the pile 106. Allowing the bearing to rotate about the tracking axis 112 within the bearing housing allows rotational movement of the torque tube 104 relative to the pile 106. Permitting rotation of the torque tube 104 about the tracking axis 112 within the bearing housing allows the PV modules 102, which may be fixedly coupled to the torque tube 104, to rotate with the torque tube 104 and track the position of the Sun as it moves across the sky. The ability of the bearing to rotate within the bearing housing 108 about one or more of the tracking axis 112, the pitch axis 114, and the yaw axis 116 may be limited by the stop mechanism.

Modifications, additions, or omissions may be made to the system 100 without departing from the scope of the present disclosure. For example, the designations of different elements in the manner described is meant to help explain concepts herein and is not limiting. Further, the system 100 may include any number of other elements or may be implemented within other systems or contexts than those described herein.

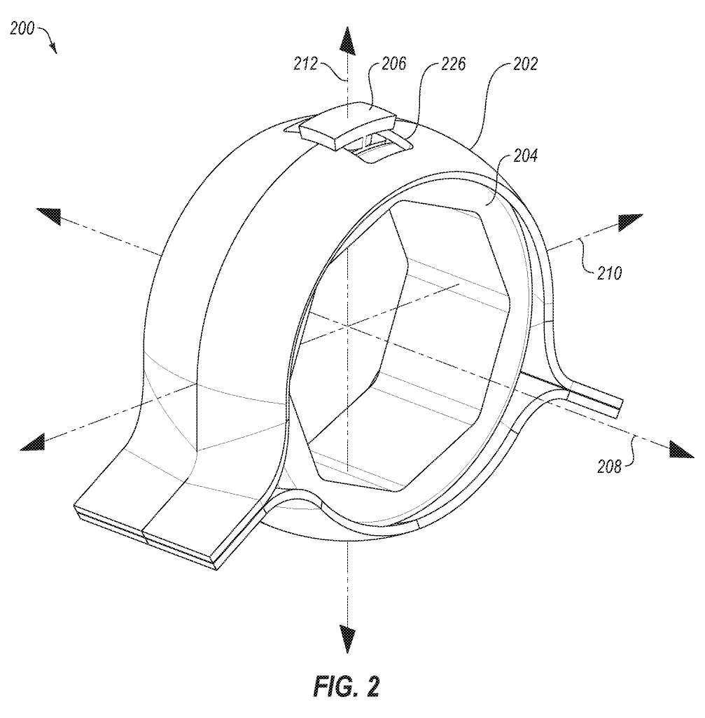

FIG. 2 illustrates a perspective view of an example variable angle torque tube interface 200. The torque tube interface 200 includes a bearing housing 202, a bearing 204, and a pin 206. The bearing 204 may be configured to be fixed to a torque tube (not shown). For example, a set screw (not shown) may be inserted through the bearing 204 and apply a frictional pressure to a torque tube in order to secure the bearing 204 to a torque tube. As discussed in more detail below, the bearing housing 202 and the bearing 204 are shaped such that the bearing 204 can rotate about a tracking axis 208, a pitch axis 210, and a yaw axis 212 within the bearing housing 202.

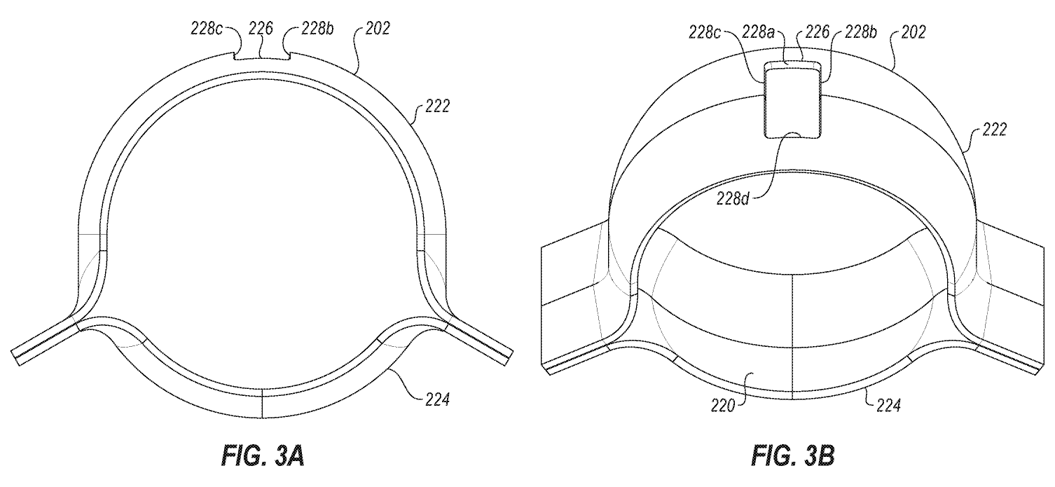

FIGS. 3A-3B illustrate the bearing housing 202 shown in FIG. 2. The bearing housing 202 may be constructed from any material including metal such as steel or aluminum or a composite material such as plastic. The bearing housing 202 includes a rounded internal surface 220. This rounded internal surface 220 may define a portion of a sphere. This rounded internal surface 220 may extend through all or a portion of the interior surface of the bearing housing 202. In some embodiments, the bearing housing 202 may be bifurcated, having an upper section 222 and a lower section 224 that may be connected to create a cavity into which the bearing 204 may be positioned. The lower section may be configured to be secured directly to a pile or indirectly to a pile through one or more mounting brackets.

The bearing housing also defines an axial channel 226. The axial channel 226 may be an elongated channel that extends in a direction that is substantially parallel with the tracking axis 208. The axial channel 226 may extend through an entire width of the bearing housing 202 such that the axial channel forms an aperture in the bearing housing 202. In these embodiments, a portion of the pin may extend outside of the bearing housing. In other embodiments, the axial channel may not extend through the bearing housing 202 to form an aperture in the bearing housing 202. In these embodiments, the axial channel 226 may be formed within the bearing housing 202 such that the pin is enclosed between the bearing housing and the bearing. The axial channel 226 may have any number of shapes. In one embodiment, the axial channel 226 may be rectangular with rounded corners. Side walls 228a-d may define the axial channel 226.

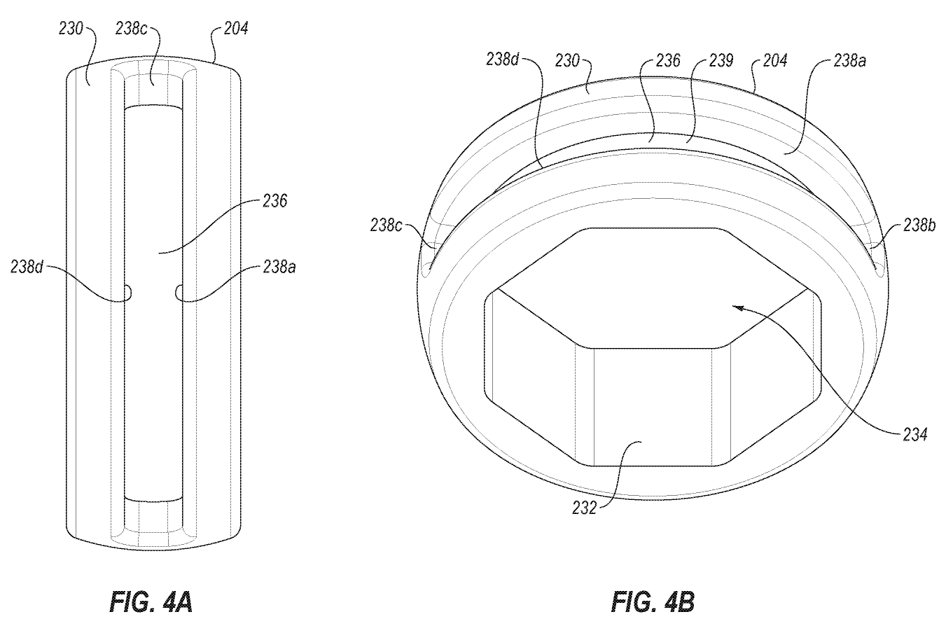

FIGS. 4A-4B illustrate the bearing 204 shown in FIG. 2. The bearing 204 may be constructed from any material including metal such as steel or aluminum or a composite material such as plastic. The bearing 204 includes a rounded external surface 230. This rounded external surface 230 may define a portion of a sphere. This rounded external surface 230 may extend through all or a portion of the external surface of the bearing 204. In some embodiments, the bearing 204 may be a single component. In other embodiments, the bearing 204 may be bifurcated, having upper and lower or side sections that may be connected. The bearing 204 includes an internal surface 232 that defines a torque tube aperture 234. A torque tube is configured to be positioned within the torque tube aperture 234.

The bearing 204 also defines a circumferential channel 236. The circumferential channel 236 may be an elongated channel that extends around a portion of a circumference of the bearing 204. In some embodiments, the circumferential channel 236 may extend less than half of an entire circumferent of the bearing 204. The circumferential channel 236 may extend through an entire thickness of the bearing 204 such that the circumferential channel forms an aperture in the bearing 204. In other embodiments, the circumferential channel may not extend through the bearing 204 to form an aperture. In these embodiments, the circumferential channel 236 may be formed in an external surface of the bearing 204. The circumferential channel 236 may have any number of shapes. In one embodiment, the circumferential channel 236 may be rectangular with rounded corners. Side walls 238a-d and a bottom 239 may define the circumferential channel 236.

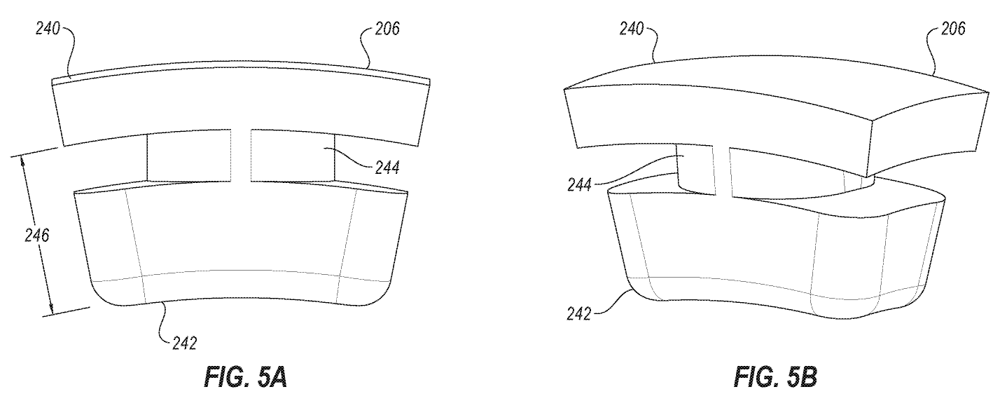

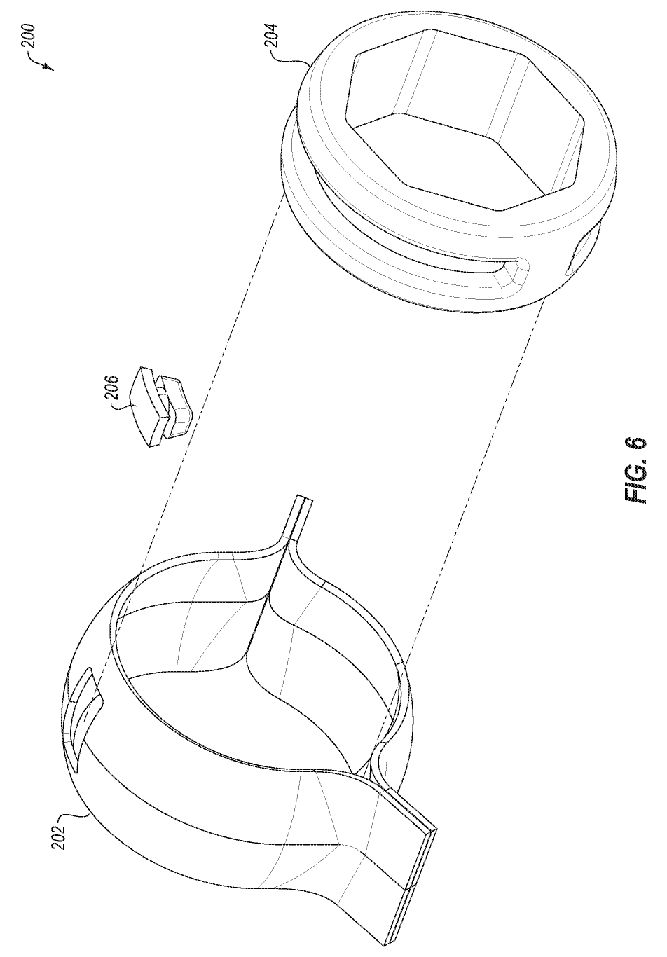

FIGS. 5A-5B illustrate the pin 206 shown in FIG. 2. The pin 206 may be constructed from any material including metal such as steel or aluminum or a composite material such as plastic. The pin 206 is configured to be positioned at least partially within the circumferential channel 236 of the bearing 204 and at least partially within the axial channel 226 of the bearing housing 202. The pin 206 is configured to allow at least some rotation by the bearing 204 within the bearing housing 202 about the tracking axis 208, the pitch axis 210, and the yaw axis 212. The pin 206 may have any number of different shapes. The shape of the pin 206 may correspond to the shapes of the circumferential and axial channels. For example, if the circumferential and axial channels are elongated ovals, the pin may be spherical or cylindrical such that it fits within the circumferential and axial channels. If the circumferential and axial channels are rectangular with rounded corners, the pin may be irregular rectangular cube or a square cube with rounded corners such that it fits within the circumferential and axial channels.

In some embodiments, the pin may have a head portion 240, a foot portion 242, and a central portion 244. The head portion 240 may be configured to extend through the axial channel 226 in the bearing housing 202 such that the central portion 244 makes contact with the side walls 228a-d that define the axial channel 226. The foot portion 242 may be sized and shaped to be seated within the circumferential channel 236 of the bearing 204. The foot portion 242 may have an irregular cube shape with rounded corners that is consistent with the shape of the circumferential channel 236. In some embodiments, a distance 246 between a bottom of the head portion 240 and a bottom of the foot portion 242 may be less that a distance between the bottom of the head portion 240 and a bottom 239 of the circumferential channel 236. Thus, when in an assembled configuration as shown in FIG. 2, the pin 206 may not contact the bottom 239 of the circumferential channel 236. Rather, the central portion 244 will contact the side walls 228a-d that define the axial channel 226 and sides of the foot portion 242 will contact the side walls 238a-d of the circumferential channel 236.

FIG. 6 illustrates an exploded view of the variable angle torque tube interface 200 shown in FIG. 2. When positioned within the bearing housing 202 (as shown in FIG. 2), the bearing 204 is configured to rotate about the tracking axis 208, the pitch axis 210, and the yaw axis 212, similar to how a ball joint rotates within a socket. The pin 206, however, may act as a hard stop to limit an amount rotation by the bearing 204 within the bearing housing 202 about one or more of the tracking axis 208, the pitch axis 210, and the yaw axis 212. For example, the pin 206 may limit an amount of rotation by the bearing 204 within the bearing housing 202 about the tracking axis 208 by butting up against the side walls 238b and 238c of the circumferential channel 236. Similarly, the pin 206 may limit an amount of rotation by the bearing 204 about the pitch axis 210 by butting up against the side walls 228a and 228d of the axial channel 226.

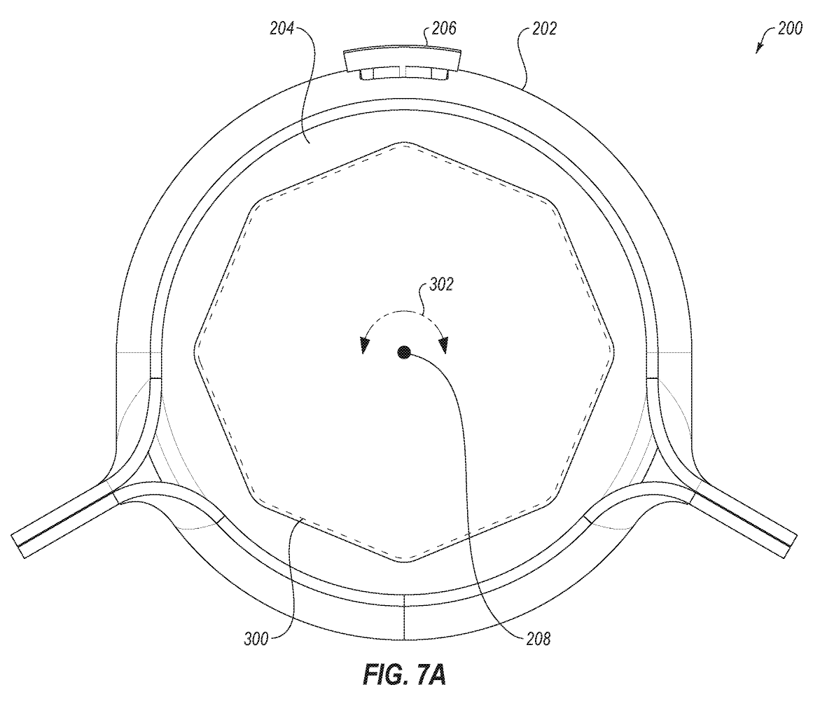

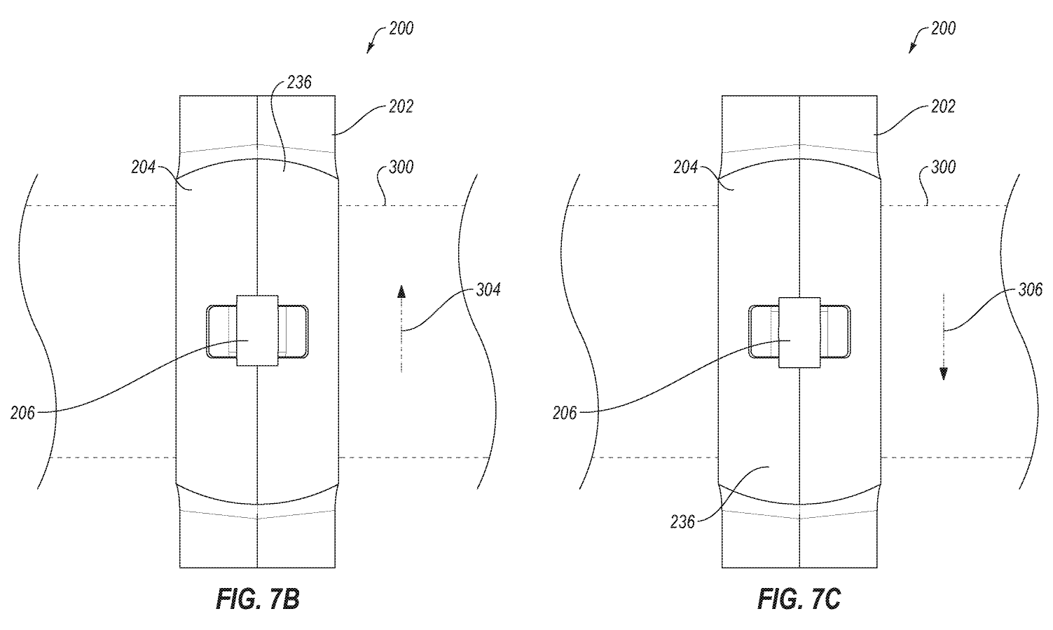

FIGS. 7A-7C illustrate different views of the variable angle torque tube interface 200 with the bearing 204 at different rotational positions about the tracking axis 208. As can be seen in FIG. 7A, the bearing 204, which is secured to a torque tube 300, can rotate about the tracking axis 208 as shown by the arrow 302. FIG. 7B illustrates the variable angle torque tube interface 200 in a first position, where the torque tube 300 has been rotated in the direction indicated by the arrow 304. In this position, the pin 206 is positioned at a first end of the circumferential channel 236 such that the pin 206 prevents any further rotation by either the bearing 204 or the torque tube 300 in the direction of the arrow 304. FIG. 7C illustrates the variable angle torque tube interface 200 in a second position, where the torque tube 300 has been rotated in the direction indicated by the arrow 306. In this position, the pin 206 is positioned at a second end of the circumferential channel 236 such that the pin 206 prevents any further rotation by either the bearing 204 or the torque tube 300 in the direction of the arrow 306.

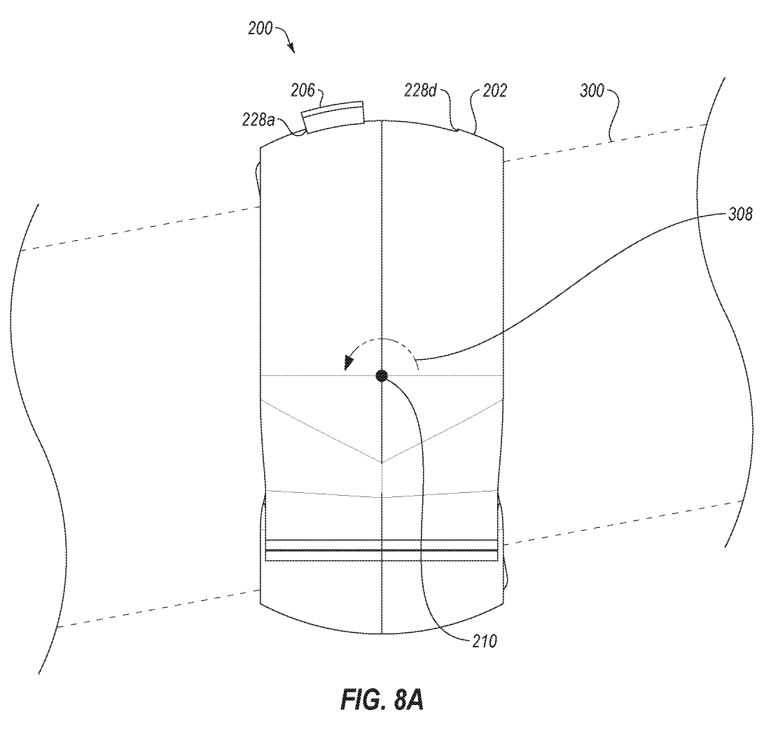

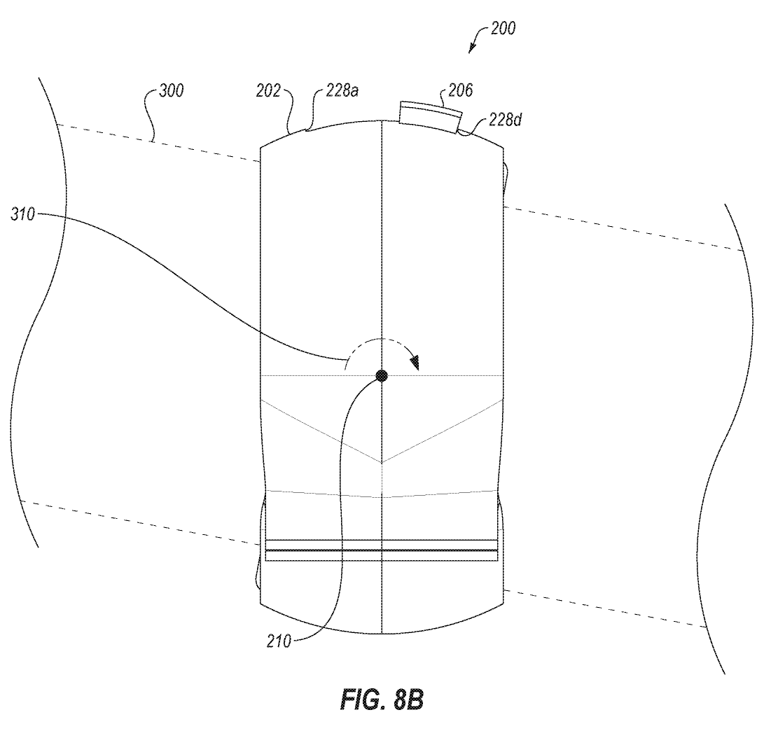

FIGS. 8A-8B illustrate different views of the variable angle torque tube interface 200 with the bearing 204 at different rotational positions about the pitch axis 210. FIG. 8A illustrates the variable angle torque tube interface 200 in a first position, where the torque tube 300 has been rotated in the direction indicated by the arrow 308. In this position, the pin 206 is positioned against the side 228a of the axial channel 226 such that the pin 206 prevents any further rotation by either the bearing 204 or the torque tube 300 in the direction of the arrow 308. FIG. 8B illustrates the variable angle torque tube interface 200 in a second position, where the torque tube 300 has been rotated in the direction indicated by the arrow 310. In this position, the pin 206 is positioned against the side 228d of the axial channel 226 such that the pin 206 prevents any further rotation by either the bearing 204 or the torque tube 300 in the direction of the arrow 310.

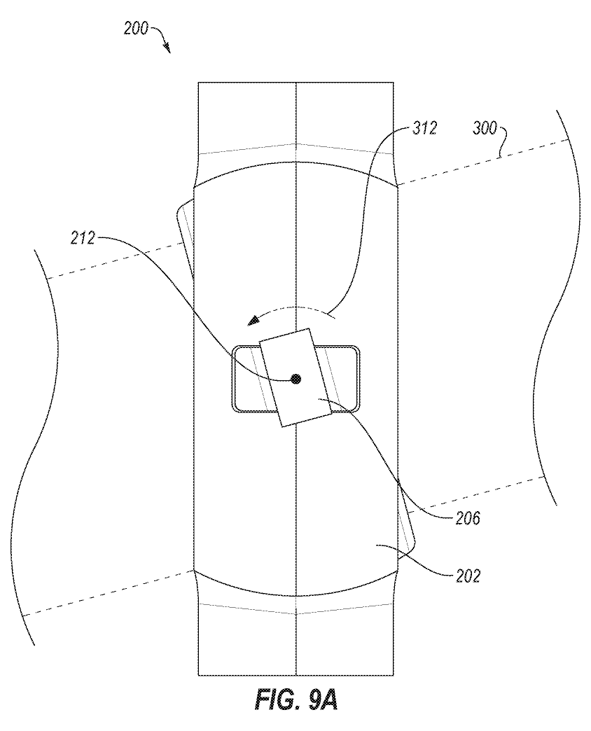

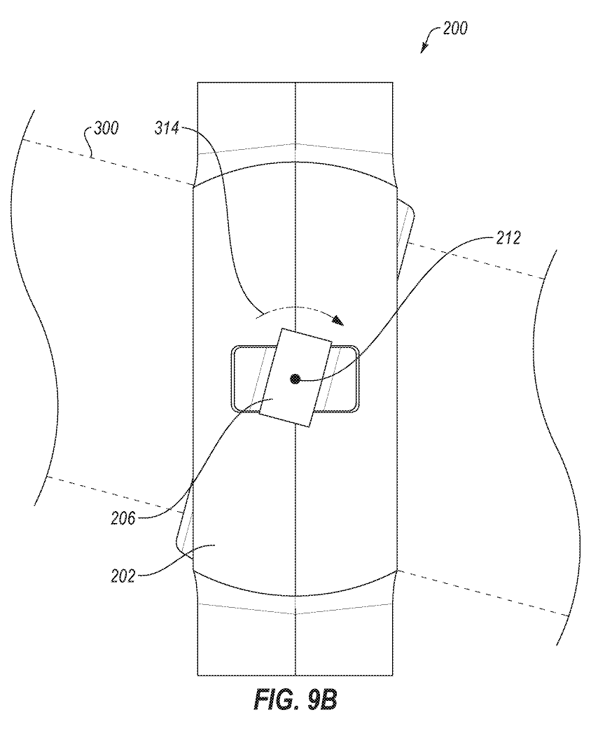

FIGS. 9A-9B illustrate different views of the variable angle torque tube interface 200 with the bearing 204 at different rotational positions about the yaw axis 212. FIG. 9A illustrates the variable angle torque tube interface 200 in a first position, where the torque tube 300 has been rotated in the direction indicated by the arrow 312. FIG. 9B illustrates the variable angle torque tube interface 200 in a second position, where the torque tube 300 has been rotated in the direction indicated by the arrow 314.

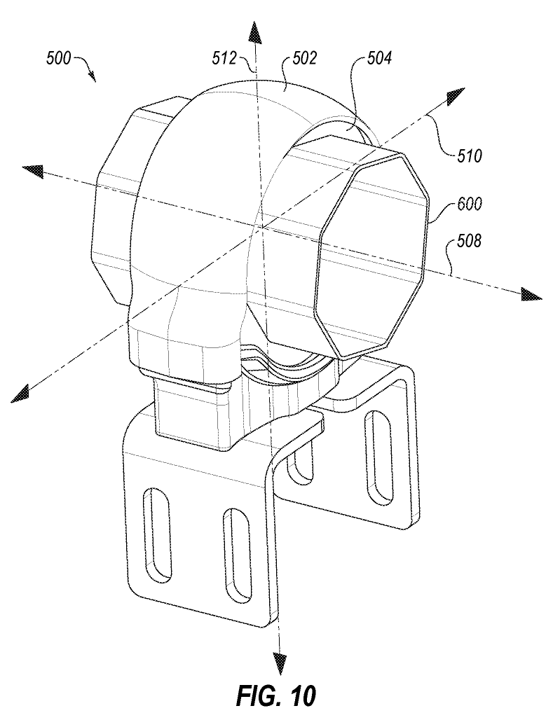

FIG. 10 illustrates a perspective view of another example variable angle torque tube interface 500. The torque tube interface 500 includes a bearing housing 502, a bearing 504, and a pin 506 (not shown in FIG. 10). The bearing 504 may be configured to be fixed to a torque tube 600. For example, a set screw (not shown) may be inserted through the bearing 504 and apply a frictional pressure to a torque tube 600 in order to secure the bearing 504 to the torque tube 600. As discussed in more detail below, the bearing housing 502 and the bearing 504 are shaped such that the bearing 504 can rotate about a tracking axis 508, a pitch axis 510, and a yaw axis 512 within the bearing housing 502.

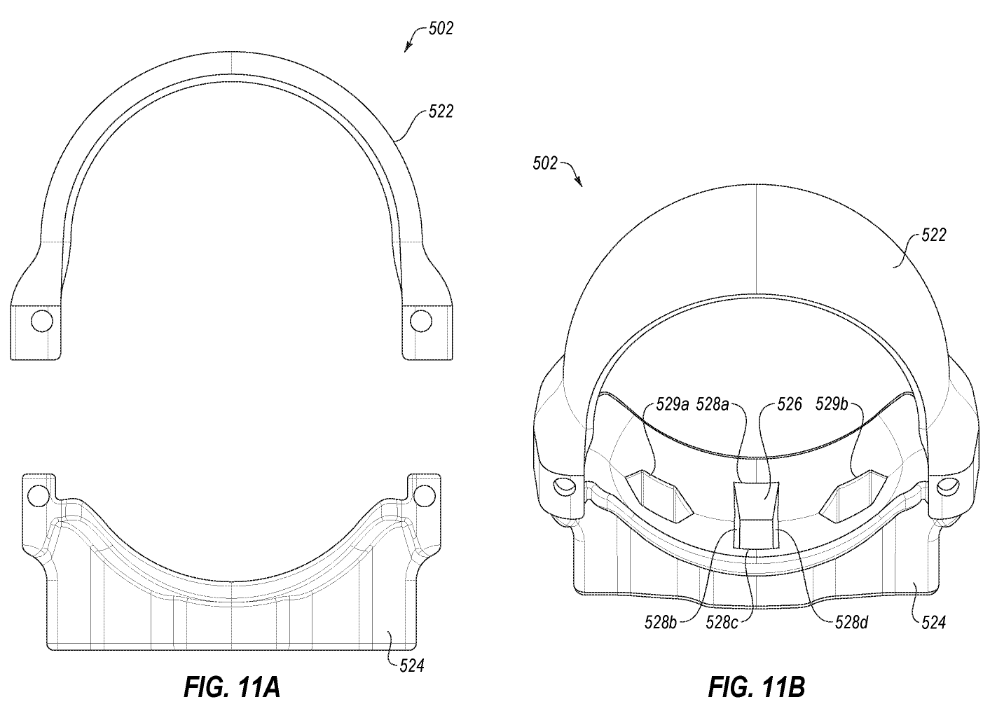

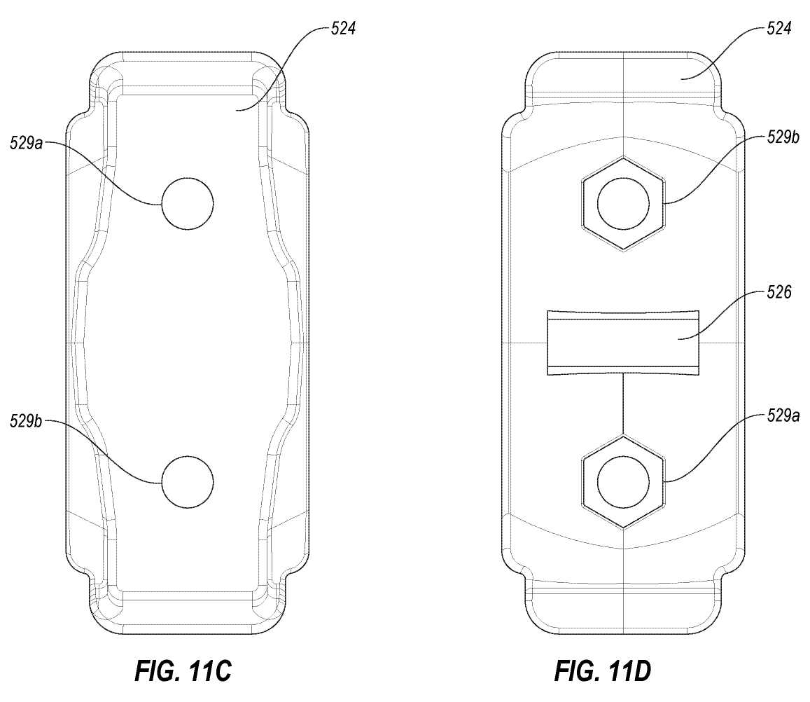

FIGS. 11A-11D illustrate the bearing housing 502 shown in FIG. 10. The bearing housing 502 may be constructed from any material including metal such as steel or aluminum or a composite material such as plastic. The bearing housing 502 includes a rounded internal surface 520. This rounded internal surface 520 may define a portion of a sphere. This rounded internal surface 520 may extend through all or a portion of the interior surface of the bearing housing 502. In some embodiments, the bearing housing 502 may be bifurcated, having an upper section 522 and a lower section 524 that may be connected to create a cavity into which the bearing 504 may be positioned. The lower section 524 may be configured to be secured directly to a pile or indirectly to a pile through one or more mounting brackets.

The bearing housing 502 also defines an axial channel 526. The axial channel 526 may be an elongated channel that extends in a direction that is substantially parallel with the tracking axis 508. The axial channel 526 may not extend through the bearing housing 502 to form an aperture in the bearing housing 502. In these embodiments, the axial channel 526 may be formed within the bearing housing 502 such that the pin, when installed, is enclosed between the bearing housing 502 and the bearing 504. The axial channel 526 may have any number of shapes. In one embodiment, the axial channel 526 may be rectangular. Side walls 528a-d may define the axial channel 526.

FIGS. 11C and 11D illustrate a top view and bottom view of the lower section 524 of the bearing housing 502. Apertures 529a and 529b extend through the lower section 524 and facilitate attachment to a pile or other mounting hardware. A top portion of these apertures 529a and 529b may have a geometric shape, such as a hexagon, to accommodate a nut or other mounting component.

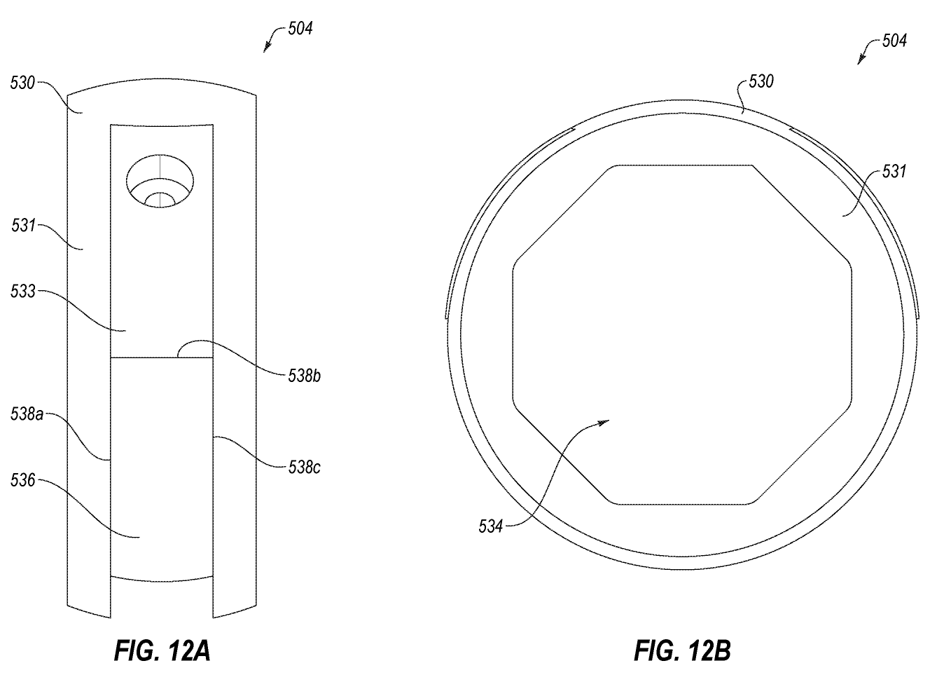

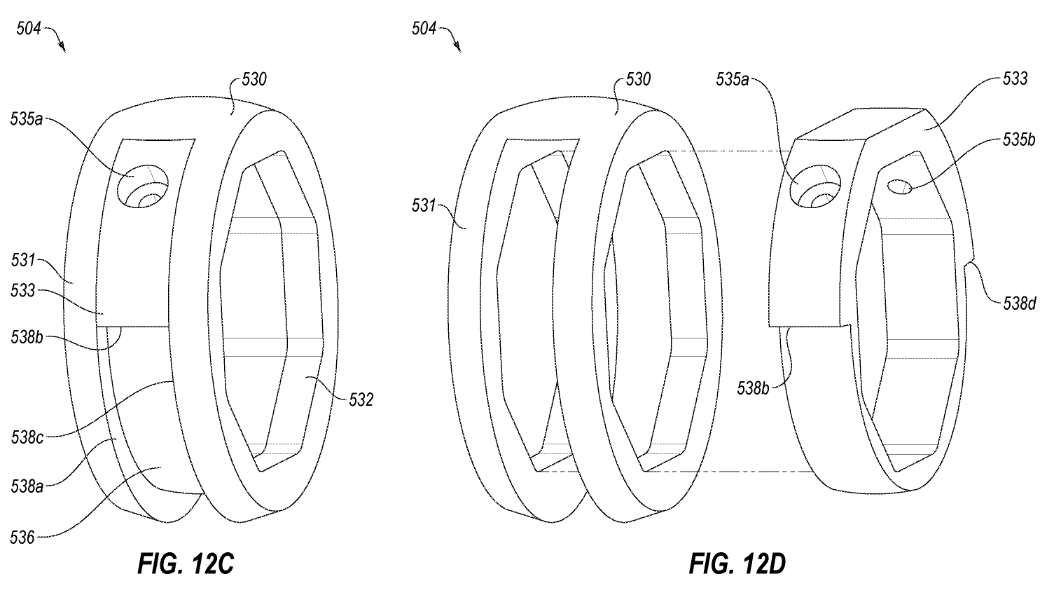

FIG. 12A-12D illustrate the bearing 504 shown in FIG. 10. The bearing 504 may be constructed from any material including metal such as steel or aluminum or a composite material such as plastic. The bearing 504 includes apertures 535a and 535b, through which set screws may secure the bearing 504 to a torque tube. The bearing 504 includes a rounded external surface 530. This rounded external surface 530 may define a portion of a sphere. This rounded external surface 530 may extend through all or a portion of the external surface of the bearing 504. The bearing 504 is bifurcated, having an outer section 531 and an inner section 533. In some embodiments, the outer and inner sections 531 and 533 may be constructed from different materials. For example, in one embodiment, the outer section 531 may be made from a composite material such as plastic. The inner section 533 may be constructed from a metal. The bearing 504 includes an internal surface 532 that defines a torque tube aperture 534. A torque tube is configured to be positioned within the torque tube aperture 534.

The bearing 504 also defines a circumferential channel 536. In some embodiments, the circumferential channel 536 may extend less than half of an entire circumferent of the bearing 504. The circumferential channel 536 may extend through an entire thickness of the bearing 504 such that the circumferential channel forms an aperture in the bearing 504. In other embodiments, the circumferential channel may not extend through the bearing 504 to form an aperture. In these embodiments, the circumferential channel 536 may be formed between the outer and inner sections 531 and 533. The circumferential channel 536 may have any number of shapes. In one embodiment, the circumferential channel 536 may be rectangular 5. Side walls 538a-d and a portion of the inner section 533 may define the circumferential channel 536.

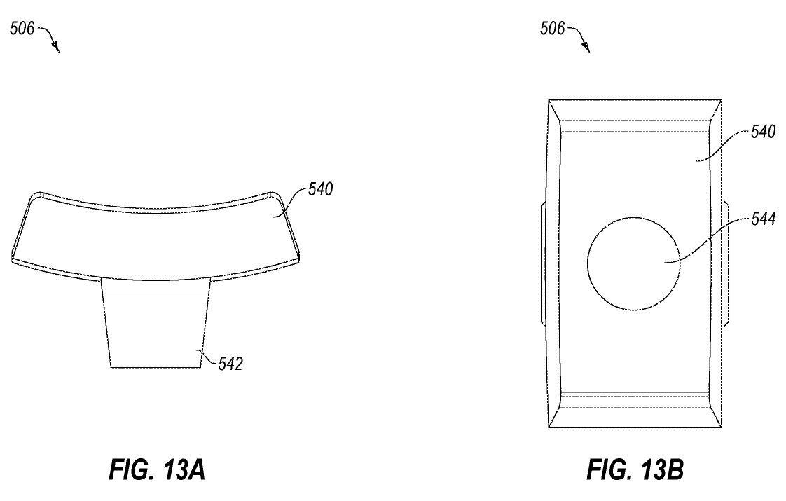

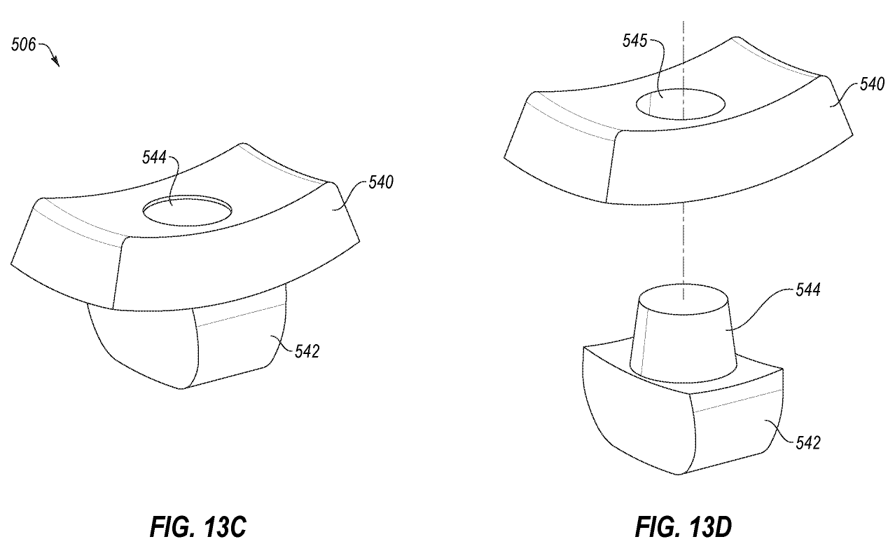

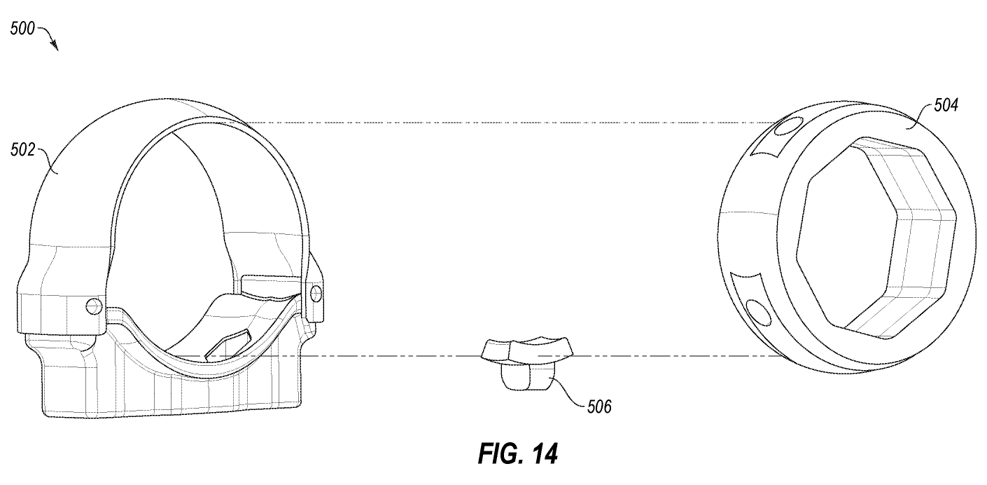

FIG. 13A-13D illustrate a pin 506 configured to be positioned at least partially within the circumferential channel 536 of the bearing 504 and at least partially within the axial channel 526 of the bearing housing 502. The pin 506 may be constructed from any material including metal such as steel or aluminum or a composite material such as plastic. The pin 506 is configured to allow at least some rotation by the bearing 504 within the bearing housing 502 about the tracking axis 508, the pitch axis 510, and the yaw axis 512. The pin 506 may have any number of different shapes. The shape of the pin 506 may correspond to the shapes of the circumferential and axial channels.

In some embodiments, the pin 506 may have a head portion 540, a foot portion 542, and a prong 544. The prong 544 is secured to the foot portion 542. The head portion 540 defines an aperture 545 into which the prong 544 extends. When connected, the prong 544 allows the head portion 540 to rotate relative to the foot portion 542. In other embodiments, a head portion may include a prong and a foot portion may define an aperture into which the prong extends.

The head portion 540 may be configured to be seated within the circumferential channel 536 of the bearing 504. The foot portion 542 may be sized and shaped to extend into the axial channel 526 in the bearing housing 502. The head and foot portions 540 and 542 may have shapes that permit accommodation within the circumferential channel 536 axial channel 526, respectively.

FIG. 14 illustrates an exploded view of the variable angle torque tube interface 500 shown in FIG. 10. When positioned within the bearing housing 502 (as shown in FIG. 10), the bearing 504 is configured to rotate about the tracking axis 508, the pitch axis 510, and the yaw axis 512, similar to how a ball joint rotates within a socket. The pin 506, however, may act as a hard stop to limit an amount rotation by the bearing 504 within the bearing housing 502 about one or more of the tracking axis 508, the pitch axis 510, and the yaw axis 512. For example, the pin 506 may limit an amount of rotation by the bearing 504 within the bearing housing 502 about the tracking axis 508 by butting up against the side walls 538b and 538d of the circumferential channel 536. Similarly, the pin 506 may limit an amount of rotation by the bearing 504 about the pitch axis 510 by butting up against the side walls 528a and 528c of the axial channel 526.

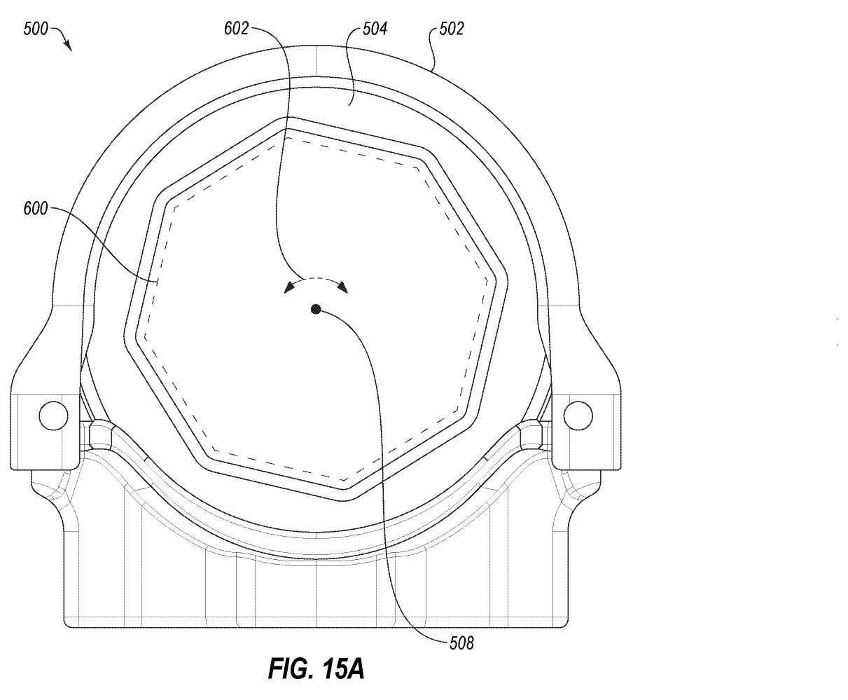

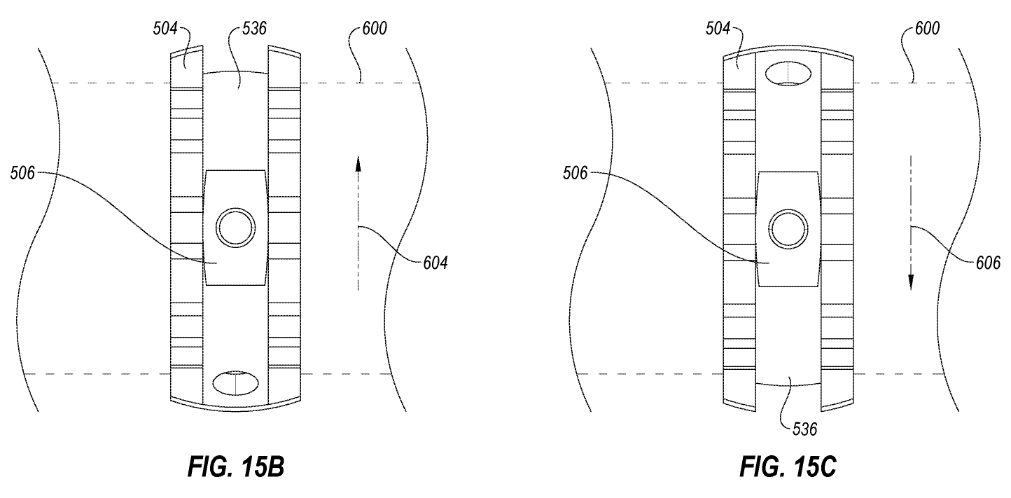

FIGS. 15A-15C illustrate different views of the variable angle torque tube interface 500 with the bearing 504 at different rotational positions about the tracking axis 508. As can be seen in FIG. 15A, the bearing 504, which is secured to a torque tube 600, can rotate about the tracking axis 508 as shown by the arrow 602. FIG. 15B illustrates the variable angle torque tube interface 500 in a first position, where the torque tube 600 has been rotated in the direction indicated by the arrow 604. In this position, the pin 506 is positioned at a first end of the circumferential channel 536 such that the pin 506 prevents any further rotation by either the bearing 504 or the torque tube 600 in the direction of the arrow 604. FIG. 15C illustrates the variable angle torque tube interface 500 in a second position, where the torque tube 600 has been rotated in the direction indicated by the arrow 606. In this position, the pin 506 is positioned at a second end of the circumferential channel 536 such that the pin 506 prevents any further rotation by either the bearing 504 or the torque tube 600 in the direction of the arrow 606.

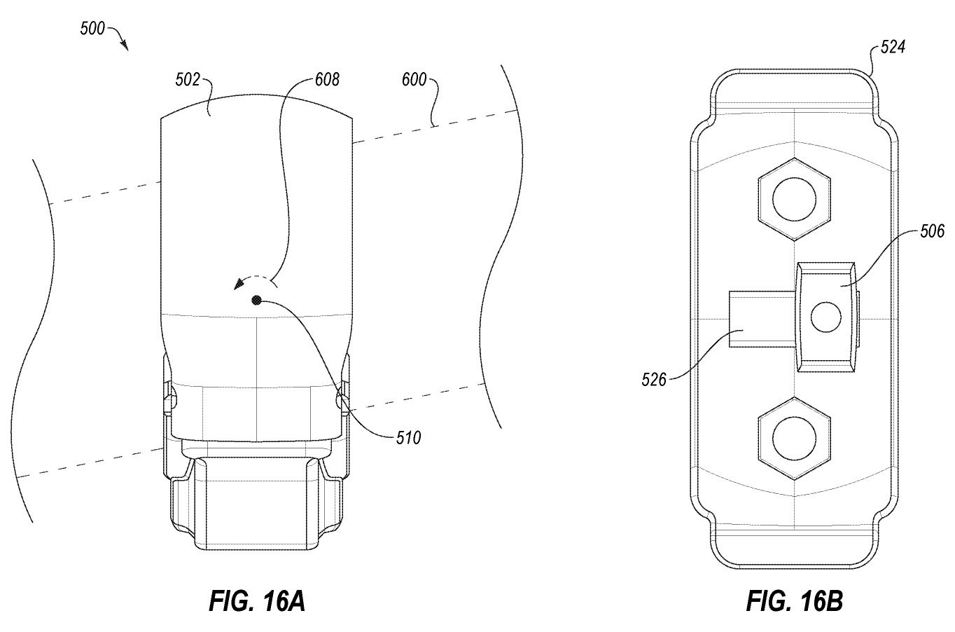

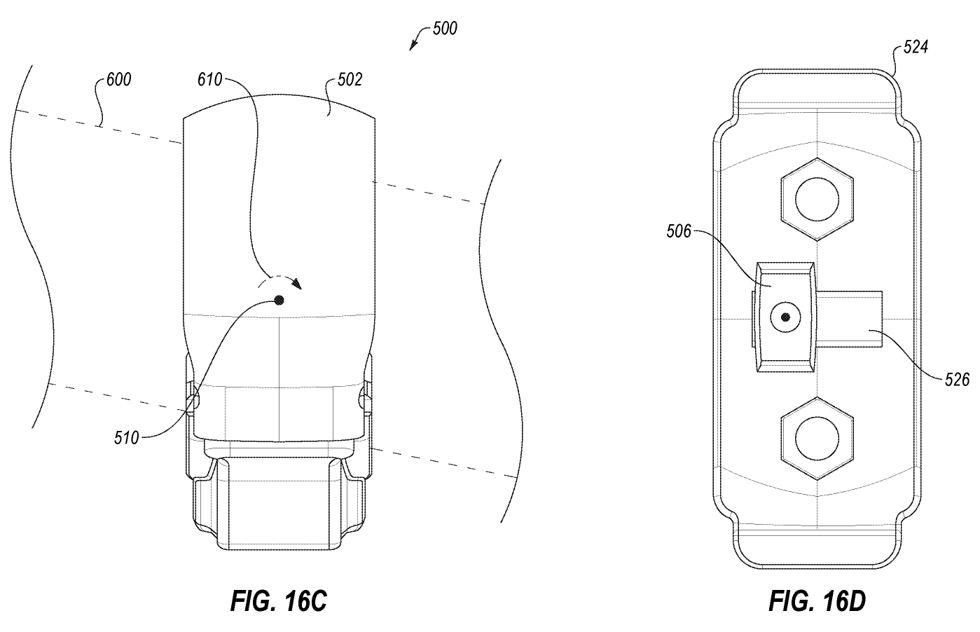

FIGS. 16A-16D illustrate different views of the variable angle torque tube interface 500 with the bearing 504 at different rotational positions about the pitch axis 510. FIG. 16A illustrates the variable angle torque tube interface 500 in a first position, where the torque tube 600 has been rotated in the direction indicated by the arrow 608. FIG. 16B illustrates a top view of the lower section 524 of the bearing housing 502. In this position, the pin 506 is positioned against one side of the axial channel 526 such that the pin 506 prevents any further rotation by either the bearing 504 or the torque tube 600 in the direction of the arrow 608. FIG. 16B illustrates the variable angle torque tube interface 500 in a second position, where the torque tube 600 has been rotated in the direction indicated by the arrow 610. FIG. 16D illustrates a top view of the lower section 524 of the bearing housing 502. In this position, the pin 506 is positioned against an opposite side of the axial channel 526 such that the pin 506 prevents any further rotation by either the bearing 504 or the torque tube 600 in the direction of the arrow 610.

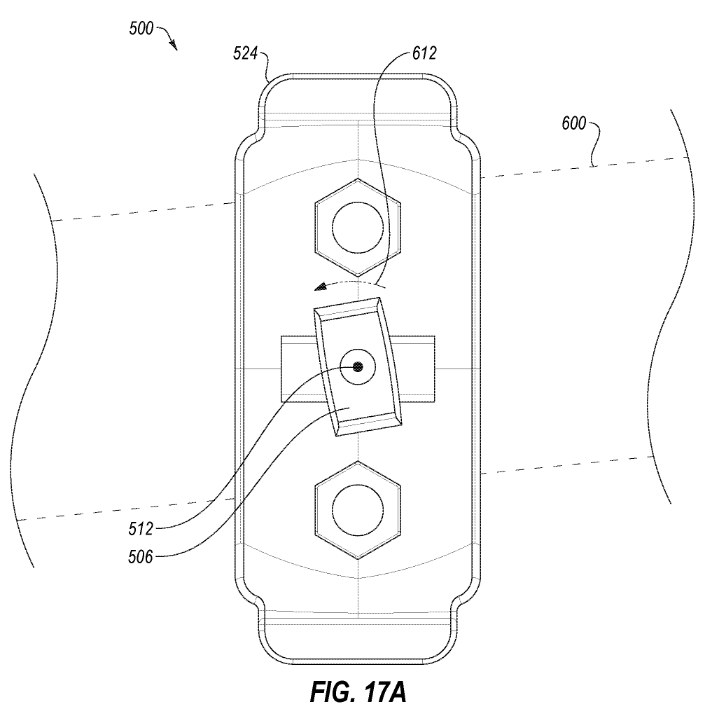

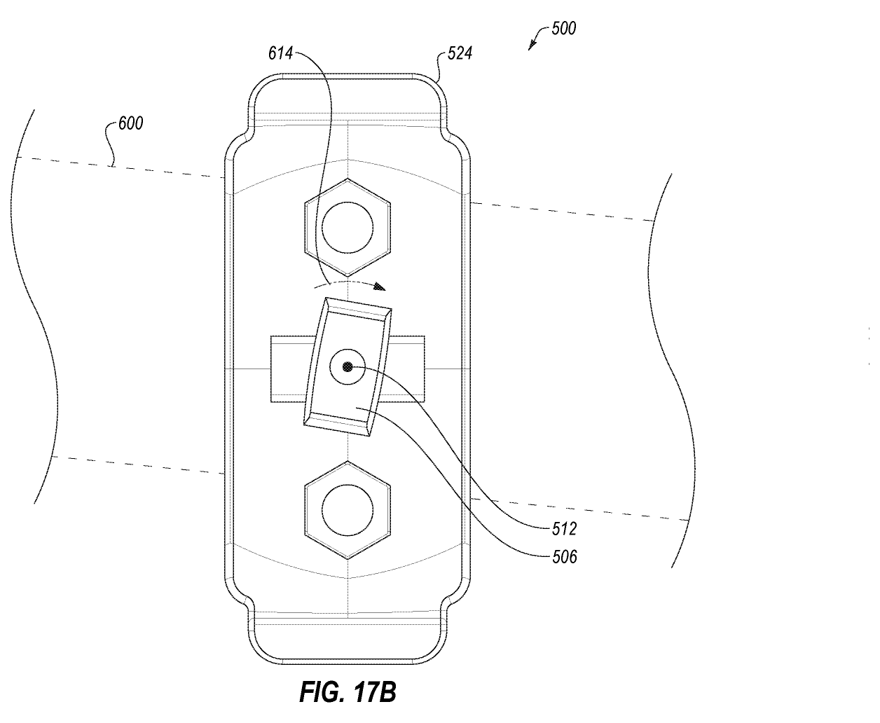

FIGS. 17A-17B illustrate different views of the variable angle torque tube interface 500 with the bearing 504 at different rotational positions about the yaw axis 512. FIG. 17A illustrates the variable angle torque tube interface 500 in a first position, where the torque tube 600 has been rotated in the direction indicated by the arrow 612. FIG. 17B illustrates the variable angle torque tube interface 500 in a second position, where the torque tube 600 has been rotated in the direction indicated by the arrow 614.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more" to introduce claim recitations.

In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A variable angle torque tube interface comprising:
a bearing configured to be attached to a torque tube, the bearing defining a circumferential channel and having a rounded external surface portion;
a bearing housing coupled to the bearing, the bearing housing defining an axial channel and having a rounded internal surface portion, wherein the rounded internal surface portion of the bearing housing interfaces with the rounded external surface portion of the bearing to allow the bearing at least some rotation within the bearing housing about a tracking axis, a pitch axis, and a yaw axis; and
a pin positioned at least partially within the circumferential channel and at least partially within the axial channel to allow the at least some rotation by the bearing within the bearing housing about the tracking axis, the pitch axis, and the yaw axis and limit an amount rotation by the bearing within the bearing housing about the tracking axis.

2. The variable angle torque tube interface of claim 1, wherein the circumferential channel is rectangular.

3. The variable angle torque tube interface of claim 1, wherein the circumferential channel on the bearing extends less than half of an entire circumference of the bearing.

4. The variable angle torque tube interface of claim 1, wherein the axial channel is rectangular.

5. The variable angle torque tube interface of claim 1, wherein the bearing housing is bifurcated and includes an upper section and a lower section.

6. The variable angle torque tube interface of claim 5, wherein the axial channel is in the upper section of the bifurcated bearing housing.

7. The variable angle torque tube interface of claim 6, wherein the axial channel in the bearing housing extends through an entire thickness of the bearing housing such that the axial channel forms an aperture in the bearing housing.

8. The variable angle torque tube interface of claim 7, wherein:
the pin comprises a head portion, a foot portion, and a central portion;
the head portion of the pin extends through the axial channel aperture and outside the bearing housing; and
the foot portion is seated within the circumferential channel.

9. The variable angle torque tube interface of claim 8, wherein the central portion is cylindrical.

10. The variable angle torque tube interface of claim 5, wherein the axial channel is in the lower section of the bifurcated bearing housing.

11. The variable angle torque tube interface of claim 10, wherein the axial channel does not extend through an entire width of the bearing housing such that the pin is enclosed between the bearing housing and the bearing.

12. The variable angle torque tube interface of claim 1, wherein the bearing is bifurcated and includes an outer component and an inner component.

13. The variable angle torque tube interface of claim 12, wherein the outer component is made of a composite material and the inner component is made of a metal.

14. The variable angle torque tube interface of claim 1, wherein the pin is bifurcated and includes a head portion and a foot portion, wherein:
at least one of the head portion and foot portion defines an aperture; and
at least one of the head portion and foot portion includes a prong that is configured to fit within the defined aperture to allow the head portion and foot portion to rotate relative to each other.

15. The variable angle torque tube interface of claim 1, wherein the pin also limits an amount of rotation by the bearing within the bearing housing about the pitch axis.

16. A variable angle torque tube interface comprising:
a bearing configured to be attached to a torque tube, the bearing defining a circumferential channel and having a rounded external surface portion;
a bearing housing coupled to the bearing, the bearing housing defining an axial channel and having a rounded internal surface portion, wherein the rounded internal surface portion of the bearing housing interfaces with the rounded external surface portion of the bearing to allow the bearing at least some rotation within the bearing housing about a tracking axis, a pitch axis, and a yaw axis; and
a pin positioned at least partially within the circumferential channel and at least partially within the axial channel to allow the at least some rotation by the bearing within the bearing housing about the tracking axis, the pitch axis, and the yaw axis and limit an amount rotation by the bearing within the bearing housing about the tracking axis;
wherein, the axial channel in the bearing housing does not extend through an entire width of the bearing housing such that the pin is enclosed between the bearing housing and the bearing.

17. The variable angle torque tube interface of claim 16, wherein the bearing housing is bifurcated and includes an upper section and a lower section.

18. The variable angle torque tube interface of claim 17, wherein the axial channel is in the lower section of the bearing housing.

19. The variable angle torque tube interface of claim 16, wherein:
the bearing is bifurcated and includes an outer component and an inner component; and
the outer component is made of a composite material and the inner component is made of a metal.

20. The variable angle torque tube interface of claim 16, wherein the pin is bifurcated and includes a head portion and a foot portion, wherein:
at least one of the head portion and foot portion defines an aperture; and
at least one of the head portion and foot portion includes a prong that is configured to fit within the defined aperture to allow the head portion and foot portion to rotate relative to each other.
